(19) United States
(12) Patent Application Publication
(10) Pub. No.: US 2006/0263579 A1
(43) Pub. Date: Nov. 23, 2006

(54) Advertising page containing micro-encapsulated material

(75) Inventor: Kenneth W. Field JR., Algonquin, IL (US)

Correspondence Address: GODFREY & KAHN S.C., 780 NORTH WATER STREET, MILWAUKEE, WI, 53202, US

(73) Assignee: Perfect Scents of Illinois, LLC., Gurnee, IL (US)

(21) Appl. No.: 11/144,560

(22) Filed: Jun. 3, 2005

Related U.S. Application Data
(60) Provisional application No. 60/576,908, filed on Jun. 4, 2004.

(51) Int. Cl. B32B 27/14

(52) U.S. Cl. 428/198

(57) ABSTRACT

A composite sheet structure can be used as an advertising page, the composite sheet structure having a sample of micro-encapsulated material applied between two opposing layers of material and attached to a carrier sheet. The composite sheet structure is constructed so that the sample can be removed from the carrier material, sampled, and optionally replaced on the carrier. The present invention also relates to a method of making such a composite sheet structure, such as can be used, for example, as an advertising page in a magazine or other publication.

This patent application claims the benefit under 35 U.S.C. 120 of Provisional patent application Ser. No. 60/576908 filed Jun. 4, 2004 and entitled “Advertising Page Containing Micro-encapsulated Material.”

### FIELD OF INVENTION

This invention relates generally to a composite sheet structure such as may be used as an advertising page, the structure carrying a quantity of micro-encapsulated material. More specifically, the present invention relates to a composite sheet structure that can be used as an advertising page, the composite sheet structure having a sample of micro-encapsulated material applied between two opposing layers of material and attached to a carrier material. The present invention also relates to such a composite sheet structure, wherein the sample can be removed from the carrier material, sampled, and optionally replaced on the carrier. The present invention also relates to a method of making such a composite sheet structure, such as can be used, for example, as an advertising page in a magazine or other publication.

### BACKGROUND OF INVENTION

Manufacturers of goods such as fragrances and cosmetics often distribute product samples to potential customers by incorporating samples into advertising pages that are inserted into publications or billing statement envelopes. This is a popular method of advertising perfumes and cosmetics.

Fragrance releasing pull-apart sheets are well known, as well as products containing such sheets. See, for example, U.S. Pat. No. 3,516,846; U.S. Pat. No. 3,685,734; U.S. Pat. No. 4,487,801; U.S. Pat. No. 4,493,869; U.S. Pat. No. 4,661,388; U.S. Pat. No. 4,720,417; U.S. Pat. No. 4,769,264; U.S. Pat. No. 4,817,860; and U.S. Pat. No. 4,889,755. In some prior art embodiments, two surfaces, sheets or opposed faces of a folded single sheet of paper are temporarily bonded together by means of an adhesive with rupturable fragrance-containing micro-capsules dispersed therein. When a user pulls the sheets apart, the micro-capsules rupture and release the fragrance contained so that it can be sampled by a user.

Such fragrance releasing pull-apart sheets can be used as advertising samples such as are enclosed in billing statements or coupon packets, or in bundled polybagged printed materials. Such fragrance sample sheets also are commonly bound into magazines, catalogs and similar publications to serve as advertisements for a particular perfume or fragrance. Various embodiments of prior art fragrance samplers and methods of their manufacture are disclosed, for example, in U.S. Pat. No. 5,188,236; U.S. Pat. No. 5,248,537; U.S. Pat. No. 5,389,174; U.S. Pat. No. 5,419,958; U.S. Pat. No. 5,918,908, U.S. Pat. No. 5,992,889; and U.S. Pat. No. 6,629,705. In certain prior art magazine inserts, the fragrance sheet is wider than a standard page of the magazine; the scent-releasing substance is disposed along an outer edge of the magazine insert page, and the edge is folded over and secured with a releasable adhesive. The user then pulls open the folded flap to release the fragrance. If the person enjoys the fragrance and wants to be able to purchase it at a later date, the user might tear off the portion of the page bearing the fragrance sample. This leaves a torn magazine page for a subsequent reader, and also can interfere with whatever advertisement or other printed matter might appear on the reverse side of the advertisement.

When the user releases the fragrance while the insert is still bound within a magazine or other publication, the released fragrance pervades not only the insert, but also several adjacent pages in the magazine. In the instances where the fragrance is offensive to the user, the user may thereafter put aside the magazine rather than continuing to endure the fragrance. The potential negative impact of such an insert on an advertisement disposed on an adjacent page is so great that publishers require the advertiser who uses a fragrance-releasing insert to purchase the adjacent pages.

A goal of fragrance pull-apart sheets is to provide the most accurate sampling of the fragrance possible. The fragrance sampler is a delicate balance of four components applied under rigid specifications. Paper, micro-capsules, adhesive, and ink each must have little or no odor so as not to interfere with the fragrance that the user is intended to experience.

Paper stocks used in the manufacture of pull-apart fragrance samplers are specifically manufactured to render four-color printing with little or no odor, and have a specific acidity. Such paper stocks are known in the art as being “scent-free.” Such scent-free paper stocks are significantly more expensive than standard paper stocks such as are commonly used in magazines and like publications. In certain fragrance sampler magazine inserts of the prior art, the entire sampler must be the size of the other pages of the magazine, even though only a small portion of the page actually contains the fragrance-releasing substance. Thus, the entire page is made of the more expensive scent-free paper stock, even though only a small portion of the page actually carries the desired fragrance sample.

Some prior art embodiments of fragrance-bearing constructions are made of continuous sheets of folded material. This type of construction severely limits the number of different fragrances that can be placed on a single advertising sheet due to the possibility of cross contamination. Sampling a fragrance in close proximity to other fragrances can cause a mixture of scents, rendering a true sampling of the fragrance impossible. In addition, certain prior art fragrance release constructions do not allow the use of UV or aqueous coatings. Since UV coatings have a strong odor, applying such coatings to the aforementioned fragrance release sheets could contaminate the sample scent. In addition, the aforementioned fragrance release constructions alter the text and graphics of the advertisement.

U.S. Pat. No. 4,661,388 to Charbonneau (1987) discloses an embodiment of a device having multiple detachable fragrance sheets stacked in layers. Although this invention allows for detachable and individual sampling of scents, it does not address the problem of cross contamination between multiple unique fragrances. Paper is not a suitable barrier to micro-encapsulated fragrances. By stacking the fragrances one on top of another, the device leaves micro-encapsulated residue on all layers. If this construction were to be used with different scents in the different layers, micro-encapsulated residue would contaminate the sample fragrances from both the top and bottom opposing sheets, thereby making the sample scents inaccurate.

The fragrance releasing device as shown in U.S. Pat. No. 4,889,755 to Charbonneau (1989) is composed of a removable strip nested between two cover sheets that define an enclosed area. The sample fragrance material is applied between the removable strip and one of the two cover sheets. The cover sheets are diecut to provide a means of removing the strip. The aforementioned device will leave behind a micro-encapsulated residue on the cover sheets. This construction is not practical for multiple fragrances. Applying multiple fragrances to the aforementioned removable strip or strips and nesting said strip or strips between two cover sheets would cause the sample fragrance material to migrate throughout the cavity between the cover sheets, thereby contaminating all fragrances therein.

It is thus one object of this invention to provide a fragrance-bearing advertising page having a fragrance-bearing portion manufactured of scent-free paper supported on a carrier portion made of a nonspecific publication grade paper.

Another object of the present invention is to provide a fragrance-bearing advertising page adapted to be permanently bound in a magazine or other publication and having a detachable fragrance releasing portion removable from the magazine.

Another object of the present invention is to provide a fragrance-bearing advertising page adapted to be permanently bound in a magazine or other publication and having a detachable fragrance releasing portion removable from the magazine, wherein the removal of the fragrance portion does not interfere with the text and graphics of the advertisement.

Another object of the present invention is to provide a fragrance-bearing advertising page wherein a plurality of detachable fragrance-releasing portions can be used without problematic cross-contamination of the fragrances.

Another object of the present invention is to provide a fragrance-bearing advertising page having a plurality of detachable fragrance-releasing portions removable from the magazine, which portions can be sampled individually and independently of competing fragrances.

Another object of the present invention is to provide a fragrance-bearing advertising page in which a UV or aqueous coating can be applied to a carrier portion without contamination of the fragrances.

Another object of the present invention is to provide a fragrance releasing insert for polybagged materials such as magazines or books.

Another object of the present invention is to provide a fragrance releasing statement enclosure such as those inserted into billing statements.

I am aware of no existing or previously developed fragrance-releasing sheet or pull-apart construction that solves these issues. The present invention provides a fragrance sampler that is easy to manufacture, addresses the problem of multiple fragrances without cross contamination, prevents potentially offensive odors from permeating publications, provides a detachable sample, allows the use of high gloss coatings such as UV coatings, allows for residual advertising, and is efficient with its use of materials.

### SUMMARY OF THE INVENTION

In accordance with the invention, a fragrance-bearing advertising page can be in the form of a composite sheet structure comprising (a) a carrier sheet, and (b) a scent-bearing structure, the scent-bearing structure comprising two layers releasably secured to one another in face-to-face mating relationship, and having a scent-releasing material disposed between said mating faces, said scent bearing structure being secured to said carrier sheet. The carrier sheet can be formed from relatively less expensive standard paper stock, while the scent-bearing structure, which can be of substantially less surface area than the area of the carrier sheet, can be formed of scent-free stock. In a preferred embodiment, the scent-bearing structure is releasably secured to the carrier sheet, such that the structure can be removed from the carrier sheet before the fragrance is released. The printing on the carrier stock can extend beneath the scent-bearing structure, such that when the scent-bearing structure is removed from the carrier sheet, the advertisement can appear to be intact, or have any other desired appearance.

The composite sheet structure of the present invention can be made by providing a carrier, providing a first layer having first and second opposing sides, securing the first side of the first layer to the carrier, applying a releasable adhesive and a scent-releasing substance to the second side of the first layer, and applying a second layer over the first layer to contain the scent-releasing substance between the first and second layers. The first and second layers with the fragrance sample in between define a scent-bearing structure. More than one such scent-bearing structure can be applied to the carrier, with the same or different scent-releasing substances applied to each of the first layers, to provide a plurality of such scent-containing structures on the carrier sheet. The composite sheet structure can be used as a stand-alone advertisement such as are used as enclosures in polybagged materials or billing inserts, or it can be bound into a publication such as a magazine or catalog.

The product of the present invention is suitable for manufacture using standard web printing press machines. One such method of making the composite sheet structure of the present invention comprises the steps of (a) providing a first web that moves through a web press in a longitudinal direction, (b) providing a second web that moves through the web press in said longitudinal direction, said second web having first and second opposed faces, each of said first and second opposed faces having first and second longitudinal regions, (c) releasably securing one of said first and second longitudinal regions on said first face of said second web to a desired location on said first web to form a composite web, (d) applying a releasable adhesive and a scent-releasing substance in at least one longitudinal region on the second face of said second web, (e) folding said second web longitudinally so that said first and second longitudinal regions of said second face thereof are in face-to-face relationship with said releasable adhesive and said scent-releasing substance disposed therebetween, and (f) cutting said composite web transversely into a plurality of composite sheet structures. Alternatively, a method of making the composite sheet structure comprises the steps of (a) providing a first web that moves through a web press in a longitudinal direction, (b) providing second and third webs that move through the web press in a longitudinal direction, (c) releasably securing the second web to the first web, (d) applying a releasable adhesive and a scent-releasing substance to the second web, (e) releasably securing the third web over the second web so that the scent-releasing substance is disposed between the second and third webs, and (f) cutting the composite web transversely into a plurality of composite sheet structures.

### DESCRIPTION OF THE DRAWINGS

Reference is next made to a brief description of the drawings, which are intended to illustrate a number of embodiments of the advertising page and methods of making the advertising page according to the present invention. The drawings and detailed descriptions which follow are intended to be merely illustrative, and are not intended to limit the scope of the invention as set forth in the appended claims.

FIG. 1(A) is a perspective view of a first embodiment of the advertisement page bound within a publication opened to expose the advertisement page;

FIG. 1(B) is a perspective view of the publication illustrated in FIG. 1(A) but in a substantially closed configuration.

FIG. 2 is a perspective view of the first embodiment of the advertisement page;

FIG. 3 is an isometric view of the first embodiment showing the detachable scent-bearing structure in relation to the carrier sheet;

FIG. 4 is an isometric view of the first embodiment showing the scent-releasing substance maintained between a first opposing layer and second opposing layer of a scent-bearing structure in relation to the carrier sheet;

FIG. 5 is a top plan view of the advertising page of FIGS. 3 and 4;

FIG. 6 is an isometric view of a second embodiment showing multiple detachable sent-bearing structures in relation to the carrier sheet;

FIG. 7 is an isometric view of a third embodiment showing multiple detachable scent-bearing structures in relation to the carrier sheet;

FIG. 8 is a perspective view of a fourth embodiment showing a detachable scent-bearing structure in relation to a multi-page carrier sheet;

FIG. 9 is an isometric view of a fifth embodiment showing two detachable scent-bearing structures created from one continuous sheet separable by means of a perforation or diecut.

FIG. 10 is a schematic diagram of a process for making the composite sheet structure of the present invention.

### DETAILED DESCRIPTION OF THE INVENTION

Various embodiments of the advertising page of the present invention will be described. Then, various methods of making the different embodiments will be described.

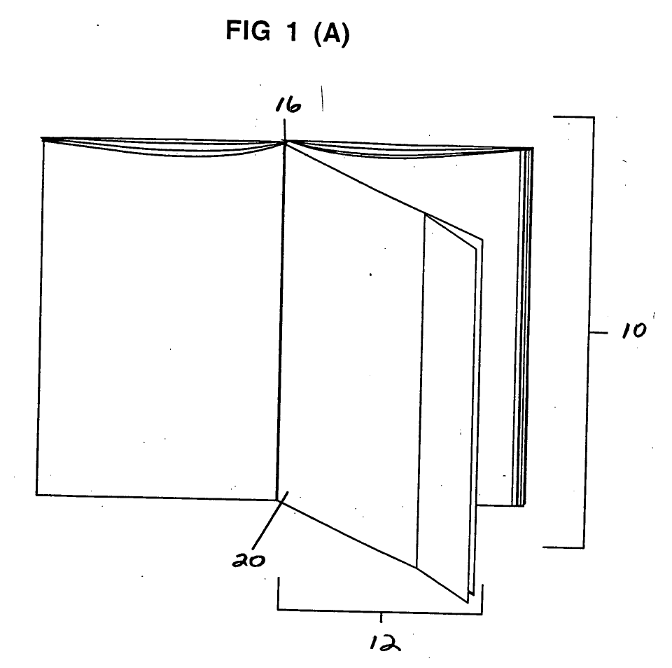

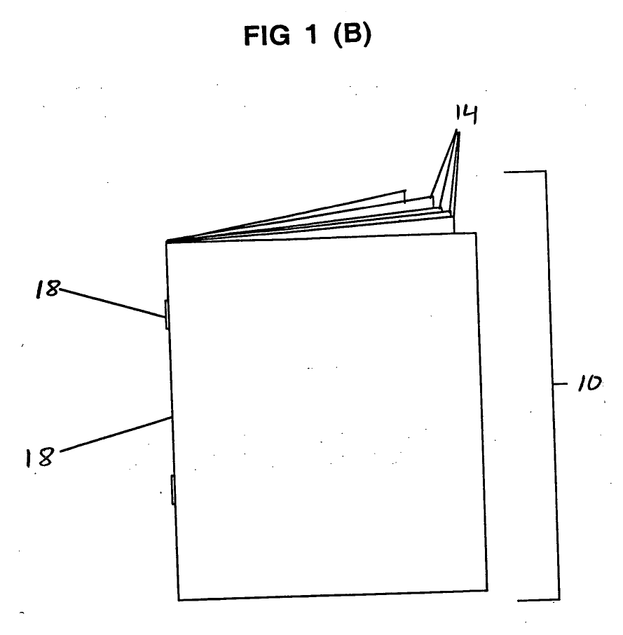

FIG. 1(A) represents a bound publication 10 containing an advertisement page 12 according to the first embodiment of the present invention. As shown in FIGS. 1(A) and (B), the publication 10 comprises a number of pages 14 and an advertisement page 12. The pages 14 are joined together at spine 16 by binding means 18, which may comprise staples, stitching, glue, tape or any other suitable binding means. As shown, the advertisement page 12 also is bound to the spine 16 at its inside edge 20 to become part of the publication 10. A single publication may contain more than one advertisement page of the present invention, and the advertisement pages may be placed at the front and back covers of the publication as well as inside the publication 10.

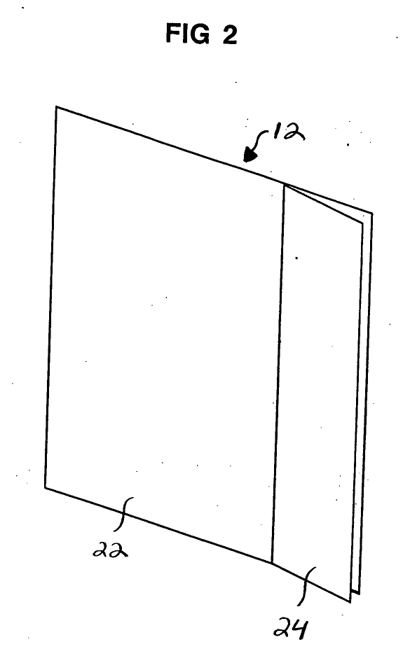

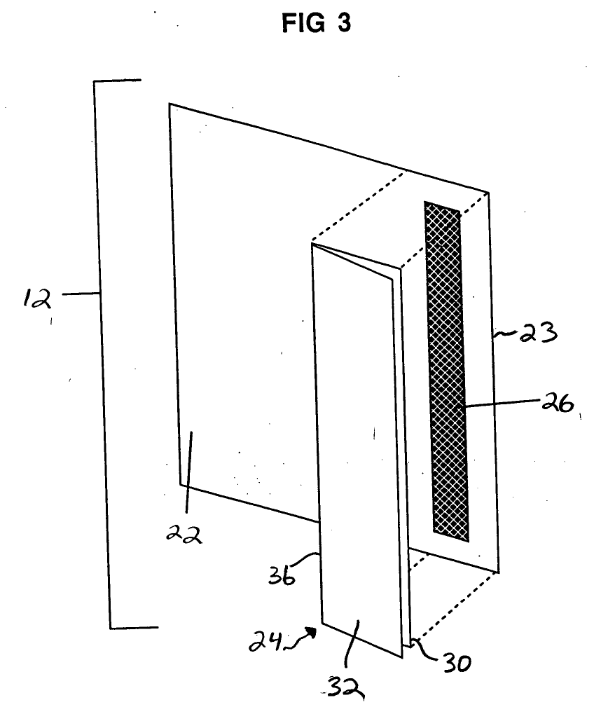

FIG. 2 represents an advertising page 12 according to the first embodiment of the present invention, before the advertising page 12 is bound into the publication 10. The advertising page 12 shown in FIG. 2 comprises a carrier sheet 22 and scent bearing structure 24 secured thereto. In a preferred embodiment, the securement between the carrier sheet 22 and scent-bearing structure 24 is a releasable securement. Referring to FIG. 3, scent-bearing structure 24 is attached to the carrier sheet 22 by means of releasable adhesive 26. The scent-bearing structure 24 and the carrier sheet 22 preferably comprise paper, but may comprise a substitute material. If desired, either or both of the carrier sheet 22 and scent-bearing structure 24 may be treated or coated for various purposes, including improved adhesion, de-adhesion, gloss, or to provide a barrier to prevent the migration of the sample material. The treatments or coatings may be applied continuously or discontinuously. The outer longitudinal edge of the carrier sheet 22 and/or the scent-bearing structure 24 may be a straight line, a curved line, a zigzag or a decorative shape. The releasable adhesive 26 may be a continuous or discontinuous line. The releasable adhesive 26 may be a cold or hot melt variety. The releasable adhesive 26 may be applied with a roller, pad, a pressurized nozzle, or other suitable application means.

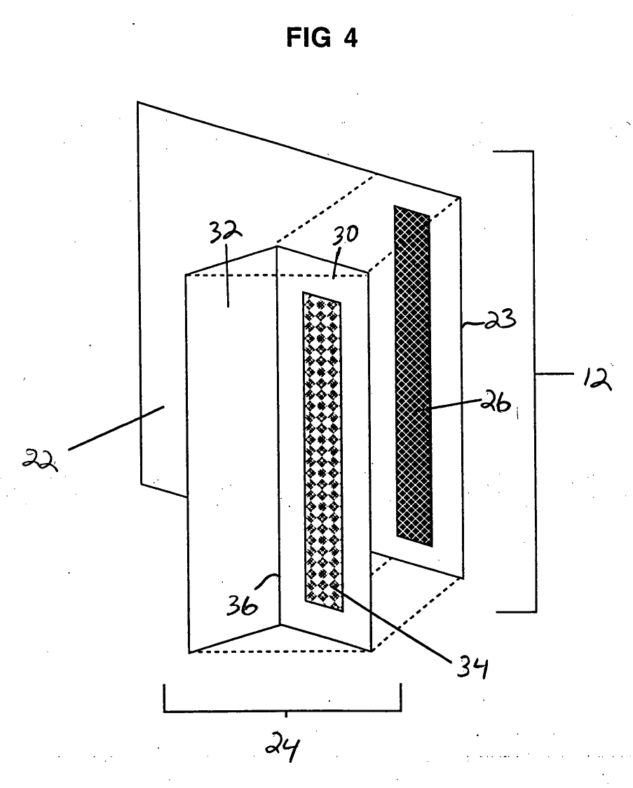

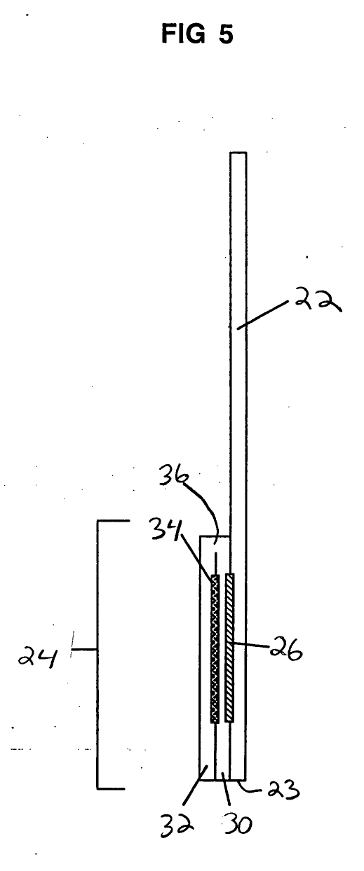

As shown in FIGS. 3-5, scent-bearing structure 24 comprises a first opposing layer 30 and second opposing layer 32 in face-to-face mating relationship. In the illustrated embodiment, the first opposing layer 30 and the second opposing layer 32 are formed from a single continuous sheet of material which has been folded over at fold line 36 and trimmed to form a scent-bearing structure 24. The first and second opposing layers 30, 32 are joined together by a mixture 34 disposed therebetween of a releasable adhesive and a scent releasing substance, such as microcapsules containing a desired fragrance. If desired, the first and second opposing layers 30, 32 may be treated or coated for various purposes, including improved adhesion, de-adhesion, or to provide a barrier to prevent the migration of the scent from one page to another in the publication. The treatments or coatings may be applied continuously or discontinuously. The mixture 34 containing the fragrance sample may be applied with a pad, roller, a pressurized nozzle, or other suitable application means.

When a user wants to sample the fragrance within the structure, the user optionally removes scent-bearing structure 24 from the carrier sheet 22 at releasable adhesive 26. In order to expose or access the sample fragrance, the user then separates second layer 32 from first layer 30, thereby breaking the bond created by the releasable adhesive in mixture 34, rupturing the microcapsules and releasing the desired fragrance. The user may return the scent bearing structure to the carrier page, or the user may take the sample as a reminder so as to enable the user to purchase the product at a later date. The graphics or text on the underlying carrier sheet are undisturbed, so that the advertisement can appear to be intact, even after the scent-bearing structure has been removed.

In the first embodiment, the carrier sheet 22 may be a non-specific publication paper stock ranging between 28# and 246# book/offset basis (25×38). The paper stock for the carrier sheet 22 can be of the same stock as the other pages of the publication 10. The paper stock used to make the scent-bearing structure 24 is made of scent-free paper, having an acidity level that will not interfere with or alter the fragrance experienced by a user. Most scent-free paper is manufactured between 60 and 80# book/offset basis (25×38), although fragrance free paper that may be manufactured between 28# and 246# book/offset basis (25×38) could be suitable for use in the present invention. Paper stocks suitable for use in the scent bearing structure 24 of the present invention include scent-free paper stocks manufactured by the Mead Westvaco paper company. Such scent-free paper stocks typically are considerably more expensive than the standard paper stock used for the carrier sheet 22. In the illustrated embodiment of FIGS. 1-5, it can be seen that the carrier sheet 22 of the common paper stock has a much larger surface area than the scent-bearing structure 24 made of scent-free paper. The present invention thus provides the manufacturer a significant cost savings, because the relatively expensive scent-free paper does not have to be used for the entire page area of the advertisement.

In the embodiment illustrated in FIGS. 3-5, the scent-bearing structure 24 is formed by folding a continuous sheet along a longitudinal fold line 36 to create the first and second opposing layers 30, 32. The scent-bearing structure 24 also may be formed by attaching two separate sheets with permanent glue on one side to create a hinge. Further, in the illustrated embodiment the fold line 36 (or glued hinge) is disposed away from the outer longitudinal edge 23 of carrier sheet 22, such that the scent-bearing structure opens in the same direction as the other pages of the publication 10; it will be appreciated, however, that the advertising page of the present invention also can be made with fold or hinge line 36 disposed substantially adjacent outer longitudinal edge 23 of carrier sheet 22, such that the scent-bearing structure 24 opens in a direction opposite that of the other pages of publication 10. Further, although the scent-bearing structure 22 is illustrated as residing adjacent an edge of carrier sheet 22, the scent-bearing structure 24 can be placed anywhere on carrier sheet 22 that the advertiser desires.

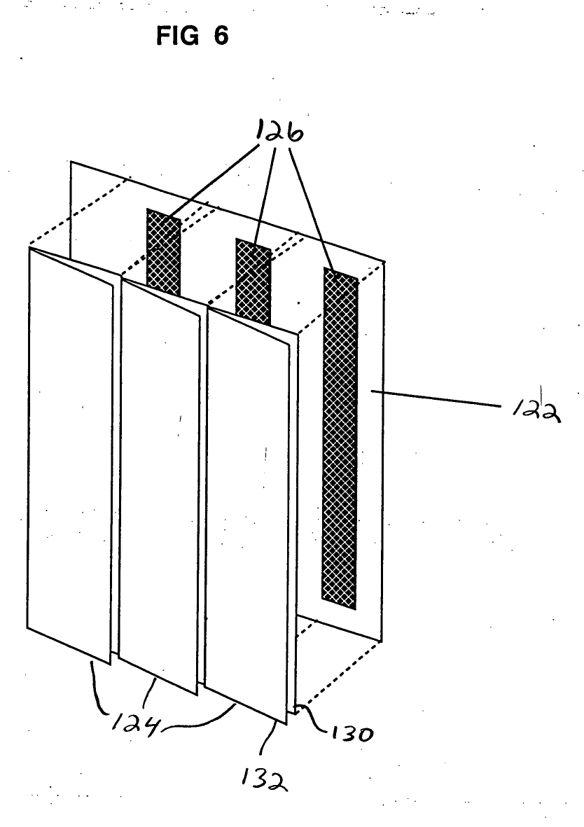

In the second embodiment shown in FIG. 6, three detachable scent-bearing structures 124 are disposed on one carrier sheet 122, and secured by releasable adhesive 126. The three detachable scent-bearing structures 124 may each contain samples of the same fragrance, if the advertiser wishes multiple users to be able to sample the same fragrance. Alternatively, each scent-bearing structure 124 may contain a unique fragrance sample different from the remaining two, so that a single user can sample several different scents. It is an advantage of the present invention that several different scents can be in proximity to one another, yet not interfere with each other, so that the user can get an accurate perception of each scent offered. The user may peel away one of the detachable scent-bearing structures 124 and separate the first and second opposing layers 130, 132 to expose the sample material contained within. The user may then keep, reattach, or discard the sampled detachable structure and choose another.

In the second embodiment of FIG. 6, the three scent bearing structures 124 and the carrier sheet 122 may all have a unique shape. The contour of the carrier sheet 122 and/or the attachable scent-bearing structures 124 may be a straight line, a curved line, a zigzag, or a decorative shape.

In the second embodiment of FIG. 6, the three detachable scent-bearing structures 124 may each have different orientations with respect to one another, such that the detachable structures 124 may be configured on the carrier sheet 122 with openable ends facing, opposing or any other formation not shown in FIG. 6.

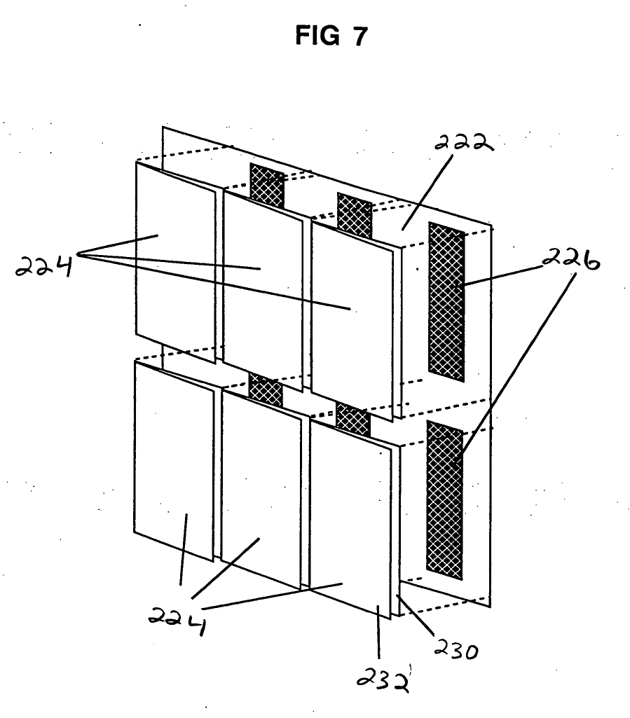

FIG. 7 illustrates a third embodiment, in which six detachable scent-bearing structures 224 are disposed on one carrier sheet 222. The six detachable structures 224 each may contain the same sample, or each may contain a unique sample different from the remaining five. The user may peel away one of the detachable structures 224 and separate the first and second opposing layers 230, 232 to expose the sample material contained within. The user may then keep, reattach, or discard the detached sample and choose another.

In the third embodiment of FIG. 7, the six detachable scent-bearing structures 224 and the carrier sheet 222 each may have a unique shape in a manner analogous to that discussed in relation to the second embodiment of FIG. 6.

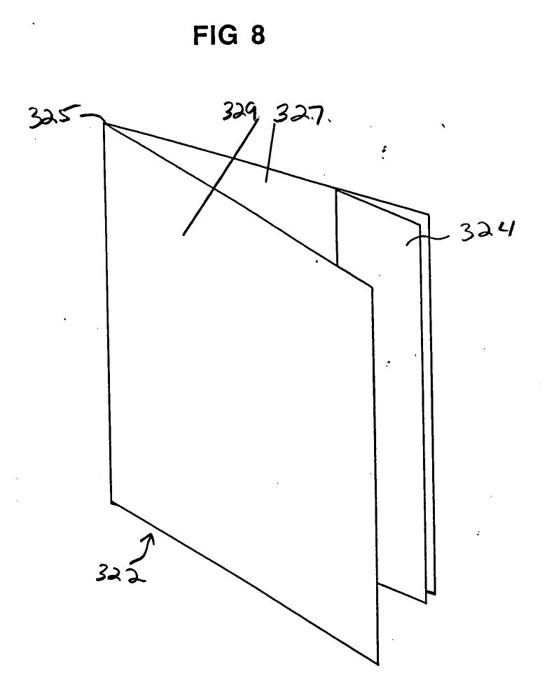

FIG. 8 illustrates a fourth embodiment in which carrier sheet 322 is in the form of a four page magazine or catalog insert. Scent bearing structure 324 is attached to carrier 322 in the same manner as discussed above, and the carrier is then folded at fold line 325 to define a multiple page carrier sheet having pages 327, 329. Although only one scent-bearing structure 324 is indicated in FIG. 8, it will be appreciated that the embodiment could encompass a plurality of scent-bearing structures, disposed at various locations on the four page carrier. Those skilled in the art will further recognize that an eight-page carrier could be made and used within the scope of the present invention, such as by binding the composite structure of FIG. 8 onto another four sided structure with a needle gluer, as is known in the art.

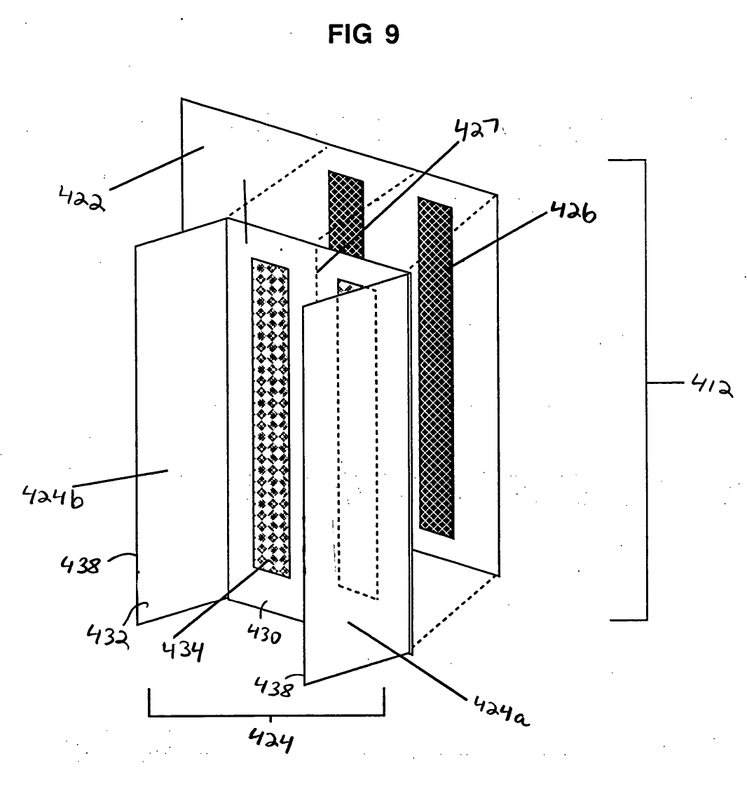

FIG. 9 illustrates a fifth embodiment 412, in which detachable scent-bearing structure 424 on a carrier sheet 422 is itself separable into two separate scent-bearing structures 424a, 424b, each structure capable of containing its own unique sample material. The structures 424a, 424b can be separated from each other along a frangible line 427, such as a perforated or die-cut line. The user chooses a fragrance to sample, and pulls on the selected structure 424a or 424b, thereby separating it from adhesive 426 and frangible line 427. The first opposing layer 430 and the second opposing layer 432 can be formed from a single continuous sheet of material which has been folded from both outside edges 438 in toward the frangible line 427, or can be formed of separate layers glued together along a mutual facing edge. The first and second opposing layer 430, 432 can be joined together by a releasable adhesive contained within the mixture 434. Further, while the embodiment of FIG. 9 is shown with a single coupled scent-bearing structure thereon, this embodiment of the invention could be made with a plurality of such coupled scent-bearing structures 424 disposed on a single carrier 422.

### Detailed Description of a Method of Making the Advertisement Page

The present invention also relates to methods of making an advertising page such as for use in a bound publication, the page having a detachable scent-bearing structure. Generally, the composite sheet structure of the present invention can be made by providing a carrier, providing a first layer having first and second opposing sides, securing the first side of the first layer to the carrier, applying a releasable adhesive and a scent-releasing substance to the second side of the first layer, applying a second layer over the first layer to contain the scent-releasing substance between the first and second layers, the first and second layers with the scent-releasing substance disposed therebetween defining a scent-bearing structure. Preferably the carrier sheet is non-specific publication stock, and the first and second layers are scent-free paper stock. The first and second layers can be an integral piece in which the second layer is folded over the first layer, or the first and second layers can be two separate pieces that are joined together along a portion thereof with a non-releasable adhesive. For example, the two layers can be joined by a line of non-releasable glue along a common facing edge to form a hinge.

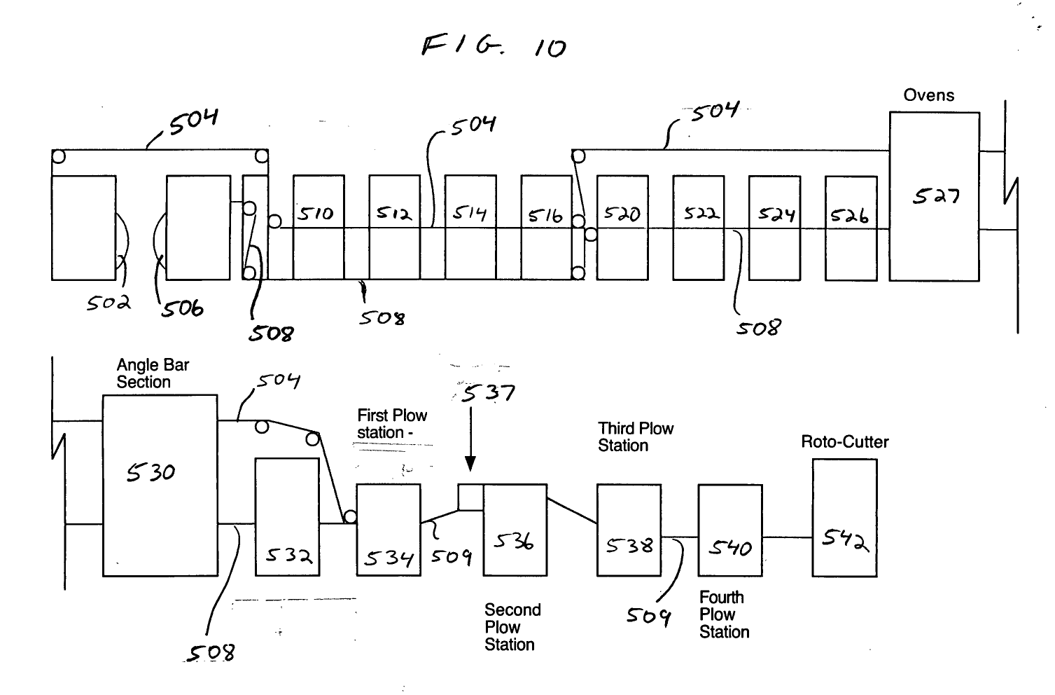

The composite structure of the present invention is well-suited to manufacture using conventional web printing machinery. Referring to FIG. 10, a double web offset printing press includes a four-station inline finishing section. Reel 502 supports web 504 of scent-free paper, while reel 506 supports web 508 of standard non-specific publication paper. Web 504 of scent free paper undergoes four color printing at printing stations 510, 512, 514, and 516, while web 508 bypasses these printing stations. Then web 508 of standard paper undergoes four color printing at printing stations 520, 522, 524, and 526, while printed scent-free web 504 bypasses those stations. Both webs pass through oven 527, which may be set at a temperature sufficient to cure the ink on the printed webs; generally within the range of about 200-400° F. The webs are then chilled to room temperature in chill station.

The webs then pass through angle bar station 530, which orients the webs for inline finishing and slits the webs to individual ribbon sizes, as may be desired for a particular end use. Web 508 of standard carrier stock can be sized such as for use as a magazine or catalog insert, while web 504 of scent free stock can be slit into a much narrower ribbon, generally twice the width of the desired final scent-bearing structure 24. Web 508 of carrier sheet stock passes through finishing station 532, which applies adhesive 26, either in a continuous line or in any desired pattern. The adhesive may be applied at station 532 with a standard pan gluer. It will be appreciated that a plurality of pan gluers can be mounted to station 532 to apply several patterns of adhesive to web 508, to accommodate a plurality of ribbons of web 504. Web 504 bypasses station 532. At first plow station 534, web 504 is brought into contact with adhesive 26 on web 508, and the two webs are adhered together to form a composite web 509. Composite web 509 passes through second plow station 536 to which is mounted wet flap gluer 537, which applies mixture 34, comprising releasable adhesive and scent-containing material, at desired locations on web 504 of composite web 509. Again, a plurality of wet-flap gluers can be mounted at station 536 to accommodate the number of ribbons cut from web 504. Generally the mixture 34 will be applied along about half the width of web 504 along one longitudinal edge. The mixture 34 is allowed to dry at room temperature. The composite web 509 then passes to third plow station 538 which creates a longitudinal fold line in web 504 such that the longitudinal portion of web 504 that bears mixture 34 is folded over onto the remaining portion of web 504. The composite web 509 then passes to fourth in-line station 540, where the composite web 509 is trimmed to reduce the size as desired and to provide clean edges. If desired, a die-cutter or “kiss” cutter, such as are known in the art, can be mounted at station 540 to cut folded web 504 into separate longitudinally disposed scent-bearing structures, without cutting through underlying carrier web 508. Such a cutter also can be used to define the frangible line 427 between structures 424a and 424b of the fifth embodiment of FIG. 9. The composite web 509 then passes to station 542 where the web is cut transversely into individual advertising pages.

Alternatively, a method of making the composite sheet structure comprises the steps of (a) providing a first web that moves through a web press in a longitudinal direction, (b) providing second and third webs that move through the web press in a longitudinal direction, (c) releasably securing the second web to the first web, (d) applying a releasable adhesive and a scent-releasing substance to the second web, (e) releasably securing the third web over the second web so that the scent-releasing substance and releasable adhesive are disposed between the second and third webs, and (f) cutting the composite web transversely into a plurality of composite sheet structures.

Those skilled in the art will recognize that many different adhesives are suitable for use in the advertisement page 10, including adhesives activated by heat, moisture, pressure and ultraviolet or other radiation. The adhesive used in the present invention to secure the scent-free web to the carrier web is preferably a fugitive cold melt adhesive. One adhesive suitable for this purpose is Craig Adhesives #3991PLV. The adhesive that is used in combination with the scent-releasing substance such as micro-capsules to form a slurry will be a fugitive adhesive with little or no odor, and having poor cohesive strength with excellent adhesive abilities. Such adhesive slurries are well-known in the art, and are described, for example, in the above-cited prior art patents.

It will be appreciated that many variations of the above-described method are possible within the scope of the present invention. For, example, the composite web 509 can be longitudinally folded after station 540 and before being transversely cut to form a four page insert. Such a four page insert can then be bonded using a standard needle gluer to another like page, with or without scented structures thereon, to make an eight page insert.

The method of the present invention involves depositing adhesive and sample material onto the first opposing layer of the detachable fragrance strip. Alternatively, the sample material and/or the adhesive may be deposited onto the second opposing layer, or onto both opposing layers without affecting the utility of the method. The second opposing layer is then brought into position material by folding the second opposing layer over the first opposing layer at the fold line of the scent-bearing structure. The first and second opposing layer are attached to each other by means of the releasable adhesive. Alternatively, the first opposing layer and the second opposing layer may be separate pieces which are subsequently joined together by a permanent adhesive to create a hinge between the first and second opposing layers.

The method of the present invention involves securing the detachable fragrance strip to a carrier sheet with releasable adhesive. Alternatively, the carrier sheet may consist of a plurality of pages whereby multiple detachable scent-bearing structures are attached within said pages. Alternatively, multiple carrier pages may be bound together by means of glue, saddle stitching, tape or any other suitable binding means.

The foregoing is a description of preferred embodiments of the present invention is presented by way of illustration and not by way of limitation. It will be understood by those skilled in the art that other variations and modifications can be made within the scope of the invention, and that such variations and modifications are embraced within the scope of the claims.

1. A composite sheet structure comprising
(a) a carrier sheet, and
(b) a scent-bearing structure, said scent-bearing structure comprising two layers releasably secured to one another in face-to-face mating relationship, and having a scent-releasing material disposed between said mating faces, said scent-bearing structure being secured to said carrier sheet.

2. The composite sheet structure of claim 1 wherein said two layers of said scent-bearing structure are formed of a single sheet.

3. The composite sheet structure of claim 1 wherein said two layers of said scent-bearing structure are formed of two distinct sheets fixedly joined along a mating portion thereof, the remaining portion thereof being releasably secured.

4. The composite sheet structure of claim 1 wherein said scent-bearing structure is releasably secured to said carrier sheet.

5. The composite sheet structure of claim 1 wherein said carrier sheet made of non-specific paper stock.

6. The composite sheet structure of claim 1 wherein said two layers of said scent-bearing structure are made of scent-free paper stock.

7. The composite sheet structure of claim 1 wherein said scent-bearing structure is secured to said carrier sheet by means of a releasable adhesive.

8. The composite sheet structure of claim 1 comprising a plurality of said scent-bearing structures secured to said carrier sheet.

9. The composite sheet structure of claim 8 wherein at least some of said plurality of scent-bearing structures are disposed laterally with respect to one another on said carrier sheet.

10. The composite sheet structure of claim 8 wherein at least some of said plurality of scent-bearing structures are disposed longitudinally with respect to one another on said carrier sheet.

11. The composite sheet structure of claim 1 wherein said scent-bearing structure is disposed along an edge of said carrier sheet.

12. The composite sheet structure of claim 1 wherein said composite sheet structure is a fragrance-releasing advertising insert for a printed publication.

13. The composite sheet structure of claim 1 wherein said composite sheet structure is a fragrance releasing advertising onsert for polybagged printed materials.

14. The composite sheet structure of claim 1 wherein said composite sheet structure is a fragrance releasing advertising enclosure for mailed materials.

15. The composite sheet structure of claim 1 wherein said carrier sheet is treated with UV coating.

16. The composite sheet structure of claim 1 wherein said carrier sheet is treated with aqueous coating.

17. A method of making a composite sheet structure, the method comprising
(a) providing a carrier,
(b) providing a first layer having first and second opposing sides,
(c) securing said first side of said first layer to said carrier,
(d) applying a releasable adhesive and a scent-releasing substance to said second side of said first layer,
(e) applying a second layer over said first layer to contain the scent-releasing substance between said first and second layers, said first and second layers with said scent-releasing substance disposed therebetween defining a scent-bearing structure.

18. The method of claim 17 wherein said first and second layers are formed of scent-free paper.

19. The method of claim 17 wherein said carrier layer is formed of non-specific paper.

20. The method of claim 17 said second layer is integral with and folded over said first layer.

21. The method of claim 17 said second layer is not integral with said first layer, said second layer and said first layer being together along a portion thereof with a non-releasable adhesive.

22. The method of claim 17 wherein a scent-bearing structure is secured to said carrier web, each scent-bearing structure being defined by a first layer, a second layer, and a scent-releasing substance disposed therebetween.

23. The method of claim 17 comprising the further step of cutting said scent-bearing structure without cutting the underlying carrier sheet.

24. The method of claim 12 wherein said first layer is securing to said carrier by means of a releasable adhesive.

25. A method of making a composite sheet structure comprising:
(a) providing a first web that moves through a web press in a longitudinal direction,
(b) providing a second web that moves through the web press in said longitudinal direction, said second web having first and second opposed faces, each of said first and second opposed faces having first and second longitudinal regions,
(c) releasably securing said one longitudinal region on said first face of said second web to a desired location on said first web to form a composite web,
(d) applying a releasable adhesive and a scent-releasing substance in at least one longitudinal region on the second face of said second web,
(e) folding said second web longitudinally so that said first and second longitudinal regions of said second face thereof are in face-to-face relationship with said releasable adhesive and said scent-releasing substance disposed therebetween,
(f) cutting said composite web transversely into a plurality of composite sheet structures.

26. A method of making the composite sheet structure comprises the steps of
(a) providing a first web that moves through a web press in a longitudinal direction,
(b) providing second and third webs that move through the web press in a longitudinal direction,
(c) releasably securing the second web to the first web,
(d) applying a releasable adhesive and a scent-releasing substance to the second web,
(e) releasably securing the third web over the second web so that the scent-releasing substance and releasable adhesive are disposed between the second and third webs, and
(f) cutting the composite web transversely into a plurality of composite sheet structures.
